(19) United States
(12) Patent Application Publication
(10) Pub. No.: US 2015/0327341 A1
(43) Pub. Date: Nov. 12, 2015

(54) CONTROL CIRCUIT OF LED LIGHTING APPARATUS

(71) Applicant: SILICON WORKS CO., LTD., Daejeon-si (KR)

(72) Inventors: Yong Guen Kim, Suwon-si (KR); Gyeong Sik Mun, Daejeon-si (KR)

(21) Appl. No.: 14/704,027

(22) Filed: May 5, 2015

(30) Foreign Application Priority Data
May 7, 2014 (KR) 10-2014-0054351

(51) Int. Cl. H05B 33/08

(52) U.S. Cl. CPC H05B 33/0818

(57) ABSTRACT

Provided is a control circuit of a light emitting diode (LED) lighting apparatus which is capable of reducing a flicker while performing a lighting operation using a rectified voltage. The control circuit may include a charge and discharge module charged to perform a charge operation using a rectified voltage and a discharge operation for LED channels, and the charge and discharge module may provide a discharge current to the LED channels during a discharge period including the lowest current point at which the level of the current supplied to the plurality of LED channels is the lowest. Thus, a flicker of the LED lighting apparatus can be reduced.

### BACKGROUND

1. Technical Field

The present disclosure relates to an LED lighting apparatus, and more particularly, to a control circuit of an LED lighting apparatus, which is capable of reducing a flicker while performing a lighting operation using a rectified voltage.

2. Related Art

According to the recent trend of lighting technology, LEDs have been employed as light sources.

A high-brightness LED is differentiated from other light sources in terms of various aspects such as energy consumption, lifetime, and light quality.

However, a lighting apparatus using LEDs as light sources requires a large number of additional circuits due to the characteristic of the LED which is driven by a constant current.

Examples of lighting apparatuses which have been developed to solve the above-described problem may include an AC direct-type lighting apparatus.

In general, the AC direct-type LED lighting apparatus is designed to rectify commercial power and drive an LED using the rectified voltage having a ripple twice larger than the commercial frequency.

Since the above-described AC direct-type LED lighting apparatus directly uses the rectified voltage as an input voltage without using an inductor and a capacitor, the AC direct-type LED lighting apparatus has a satisfactory power factor.

Each of the LEDs included in the LED lighting apparatus may be designed to operate at 2.8V or 3.8V, for example. Furthermore, the LED lighting apparatus may be designed to be operated by a rectified voltage having a level at which a large number of LEDs connected in series can emit light.

As ripples of the rectified voltage increase/decrease, a large number of LEDs included in the LED lighting apparatus may be sequentially turned on/off at each LED channel.

Since the rectified voltage which is supplied to drive the LED lighting apparatus has ripples, the rectified voltage has a section in which it falls to such a level that the LED channels cannot emit light.

That is, the rectified voltage of the LED lighting apparatus substantially falls below the light emitting voltage of the LEDs due to the ripples. Thus, the current supplied to each LED channel has a section in which the current falls to the lowest current and then rises.

When the entire LED channels are temporarily turned off, a flicker may occur. The flicker may degrade a use feeling of a user or increase fatigue degree of the user.

Therefore, the LED lighting apparatus which is driven according to the rectified voltage characteristic needs to be designed to improve the flicker level.

### SUMMARY

Various embodiments are directed to a control circuit of an LED light apparatus, which is capable of reducing a flicker while the LED lighting apparatus emits light.

Also, various embodiments are directed to a control circuit of an LED lighting apparatus, which is capable of reducing a flicker by performing a charge operation using a rectified voltage and a discharge operation corresponding to a change of the rectified voltage.

In an embodiment, there is provided a control circuit of an LED lighting apparatus which includes a plurality of LED channels. The control circuit may include: a current control circuit configured to provide current a path corresponding to sequential light emissions of the plurality of LED channels in response to a rectified voltage; and a flicker reduction circuit including a charge and discharge module charged to the rectified voltage and providing a discharge current to the plurality of LED channels, and configured to provide the discharge current to the plurality of LED channels during a discharge period including the lowest current point at which the level of the current supplied to the plurality of LED channels is the lowest.

In another embodiment, there is provided a control circuit of an LED lighting apparatus which includes a plurality of LED channels. The control circuit may include a flicker reduction circuit formed at a position to which a rectified voltage for the plurality of LED channels is applied. The flicker reduction circuit may include: a charge and discharge module charged to the rectified voltage and configured to provide a discharge current to the plurality of LED channels; and a discharge control circuit configured to provide the discharge current of the charge and discharge module to the plurality of LED channels during a discharge period including the lowest current period at which the amount of current supplied to the plurality of LED channels is the lowest.

### BRIEF DESCRIPTION OF THE DRAWINGS

FIG. 1 is a circuit diagram illustrating a control circuit of an LED lighting apparatus in accordance with an embodiment of the present invention.

FIG. 2 is a detailed circuit diagram of a current control circuit of FIG. 1.

FIG. 3 is a circuit diagram illustrating an example of a flicker reduction circuit of FIG. 1.

FIG. 4 is a circuit diagram illustrating another example of the flicker reduction circuit of FIG. 1.

FIG. 5 is a waveform diagram for describing the occurrence of a flicker in a general LED lighting apparatus.

FIG. 6 is a waveform diagram for describing the operation of the control circuit of the LED lighting apparatus in accordance with the embodiment of the present invention.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

Embodiments of the present invention disclose a control circuit of an AC direct-type LED lighting apparatus.

A rectified voltage for driving an LED through an AC direct-type LED lighting apparatus may indicate a voltage having a ripple which is obtained by full-wave rectifying an AC voltage and repetitively rises and falls. In an embodiment of the present invention, a rectified voltage is represented by Vrec.

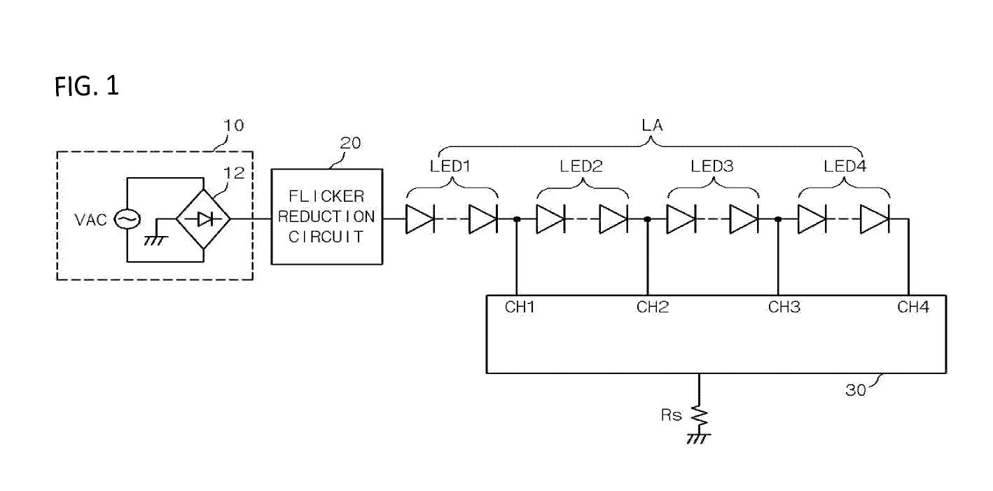

The control circuit of the LED lighting apparatus in accordance with the embodiment of the present invention may be configured to perform current regulation for light emission of a lamp LA as illustrated in FIG. 1.

Referring to FIG. 1, the control circuit of the LED lighting apparatus in accordance with the embodiment of the present invention may include a lamp LA, a power supply unit 10, a flicker reduction circuit 20, and a current control circuit 30.

The lamp LA may include LEDs which are divided into a plurality of LED channels LED1 to LED4. The LED channels of the lamp LA may be sequentially turned on/off according to ripples of the rectified voltage Vrec provided from the power supply unit.

FIG. 1 illustrates that the lamp LA includes four LED channels LED1 to LED4. Each of the LED channels LED1 to LED4 may include an equal or different number of LEDs, and a dotted line in each of the LED channels LED1 to LED4 indicates that illustration of the LEDs is omitted. A current supplied to the LED channels LED1 to LED4 may be referred to as a light emitting current, and represented by If.

The power supply unit 10 may provide a rectified voltage Vrec obtained by converting an AC voltage to the lamp LA through the flicker reduction circuit 20, and output a rectified voltage Vrec obtained by rectifying an AC voltage.

The power supply unit 10 may include a power supply VAC for providing an AC voltage and a rectification circuit 12 configured to output the rectified voltage Vrec by rectifying the AC voltage provided from the power supply VAC. The power supply VAC may include a commercial AC power supply.

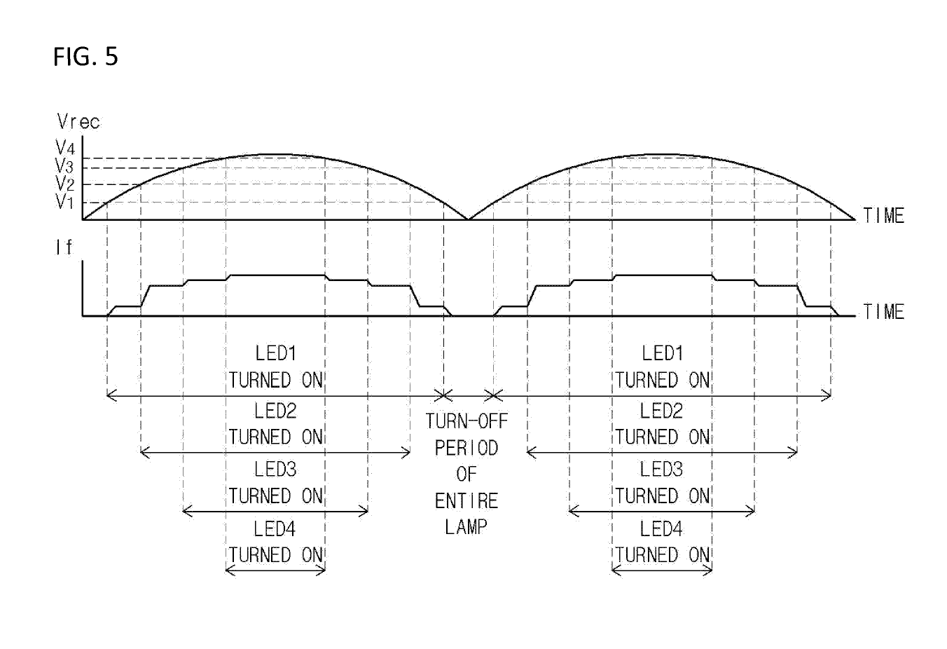

The rectification circuit 12 may full-wave rectify an AC voltage having a sine-wave from the power supply VAC, and output the rectified voltage Vrec. That is, the rectification circuit 12 may output the rectified voltage Vrec obtained by converting the negative polarity of the AC voltage into the positive polarity. Thus, as illustrated in FIG. 5, the rectified voltage Vrec may have a ripple at which the voltage level rises and falls on a basis of the half cycle of the AC voltage. In the embodiment of the present invention, the rise or fall of the rectified voltage Vrec may indicate a rise or fall of the ripple. The current provided from the rectification circuit 12 may be represented by Irec.

The current control circuit 30 may perform current regulation for light emission of the LED channels LED1 to LED4, and provide a current path for light emission to each LED channel.

The current control circuit 30 may use a current sensing resistor Rs of which one end is grounded, in order to form a current path through current regulation.

In the embodiment of the present invention, the LED channels LED1 to LED4 of the lamp LA may be sequentially turned on or off in response to the rise or fall of the rectified voltage Vrec.

When the rectified voltage Vrec rises to sequentially reach the light emitting voltages of the respective LED channels LED1 to LED4, the current control circuit 30 may provide a current path for light emission to the respective LED channels LED1 to LED4. In the current control circuit 30, CH1 to CH4 represent terminals for providing the current path to the respective LED channels LED1 to LED4.

At this time, a light emitting voltage V4 which causes the LED channel LED4 to emit light may be defined as a voltage at which the LED channels LED1 to LED4 can emit light, a light emitting voltage V3 which causes the LED channel LED3 to emit light may be defined as a voltage at which the LED channels LED1, LED2, and LED3 can emit light, a light emitting voltage V2 which causes the LED channel LED2 to emit light may be defined as a voltage at which the LED channels LED1 and LED2 can emit light, and a light emitting voltage V1 which causes the LED channel LED1 to emit light may be defined as a voltage at which only the LED channel LED1 can emit light.

The current control circuit 30 may be configured to use a current sensing voltage of the current sensing resistor Rs. The current sensing voltage may be varied by a current path which is differently formed depending on the light emitting state of each LED channel of the lamp LA. At this time, the current path may be formed in the current control circuit 30, and a current flowing through the current sensing resistor Rs may include a constant current, and correspond to the light emitting current If.

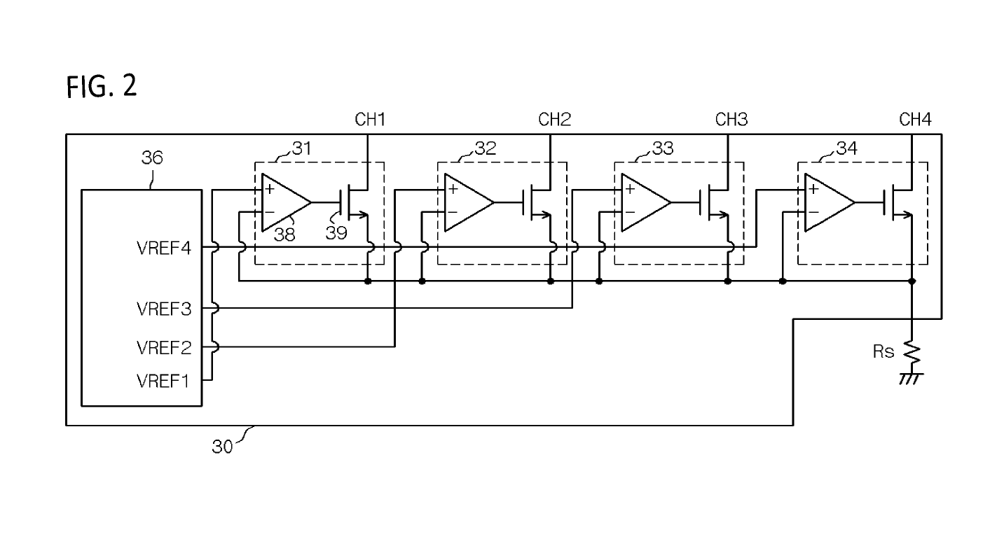

The current control circuit 30 may be configured as illustrated in FIG. 2. Referring to FIG. 2, the current control circuit 30 may include a plurality of switching circuits 31 to 34 configured to provide a current path for the LED channels LED1 to LED4 and a reference voltage supply unit 36 configured to provide reference voltages VREF1 to VREF4.

The reference voltage supply unit 36 may be configured to provide the reference voltages VREF1 to VREF4 having different levels according to a designer's intention.

The reference voltage supply unit 36 may include a plurality of resistors which are connected in series so as to receive a constant voltage, for example, output the reference voltages VREF1 to VREF4 having different levels through nodes between the respective resistors. In another embodiment, the reference voltage supply unit 36 may include independent voltage supply sources for providing the reference voltages VREF1 to VREF4 having different levels.

Among the reference voltages VREF1 to VREF4 having different levels, the reference voltage VREF1 may have the lowest voltage level, and the reference voltage VREF4 may have the highest voltage level. The voltage level may gradually increase in order of the reference voltages VREF1, VREF2, VREF3, and VREF4.

The reference voltage VREF1 may have a level for turning off the switching circuit 31 when the LED channel LED2 emits light. More specifically, the reference voltage VREF1 may be set to a lower level than a current sensing voltage which is formed in the current sensing resistor Rs by the light emitting voltage V2 of the LED channel LED2.

The reference voltage VREF2 may have a level for turning off the switching circuit 32 when the LED channel LED3 emits light. More specifically, the reference voltage VREF2 may be set to a lower level than a current sensing voltage which is formed in the current sensing resistor Rs by the light emitting voltage V3 of the LED channel LED3.

The reference voltage VREF3 may have a level for turning off the switching circuit 33 when the LED channel LED4 emits light. More specifically, the reference voltage VREF3 may be set to a lower level than a current sensing voltage which is formed in the current sensing resistor Rs by the light emitting voltage V4 of the LED channel LED4.

The reference voltage VREF4 may be set to such a level that the current formed in the current sensing resistor Rs becomes a constant current in the upper limit region of the rectified voltage.

The switching circuits 31 to 34 may be commonly connected to the current sensing resistor Rs which provides a current sensing voltage for current regulation and current path formation.

The switching circuits 31 to 34 may compare the current sensing voltage of the current sensing resistor Rs to the reference voltages VREF1 to VREF4 of a reference voltage generation circuit, and form a selective current path for turning on the lamp LA.

Each of the switching circuits 31 to 34 may receive a high-level reference voltage as the switching circuit is connected to an LED channel away from the position to which the rectified voltage Vrec is applied.

Each of the switching circuits 31 to 34 may include a comparator 38 and a switching element, and the switching element may include an NMOS transistor 39.

The comparator 38 in each of the switching circuits 31 to 34 may have a positive input terminal (+) configured to receive a reference voltage, a negative input terminal (−) configured to receive a current sensing voltage, and an output terminal configured to output a comparison result between the reference voltage and the current sensing voltage.

The NMOS transistor 39 in each of the switching circuits 31 to 34 may perform a switching operation according to the output of the comparator 38, which is applied through the gate thereof.

The flicker reduction circuit 20 may include a charge and discharge module which is charged to the rectified voltage Vrec and provides a discharge current to the plurality of LED channels LED1 to LED4. The flicker reduction circuit 20 may provide a discharge current to the plurality of LED channels LED1 to LED4 during a discharge period.

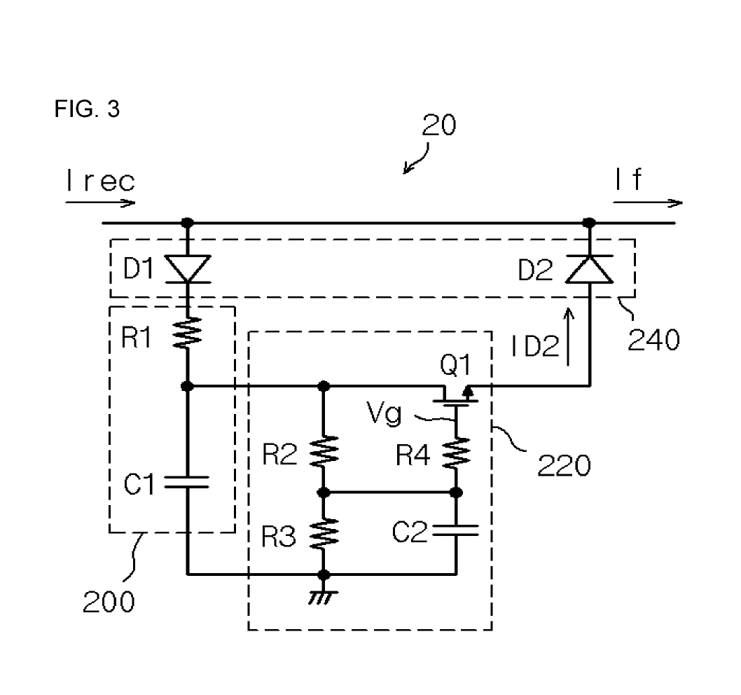

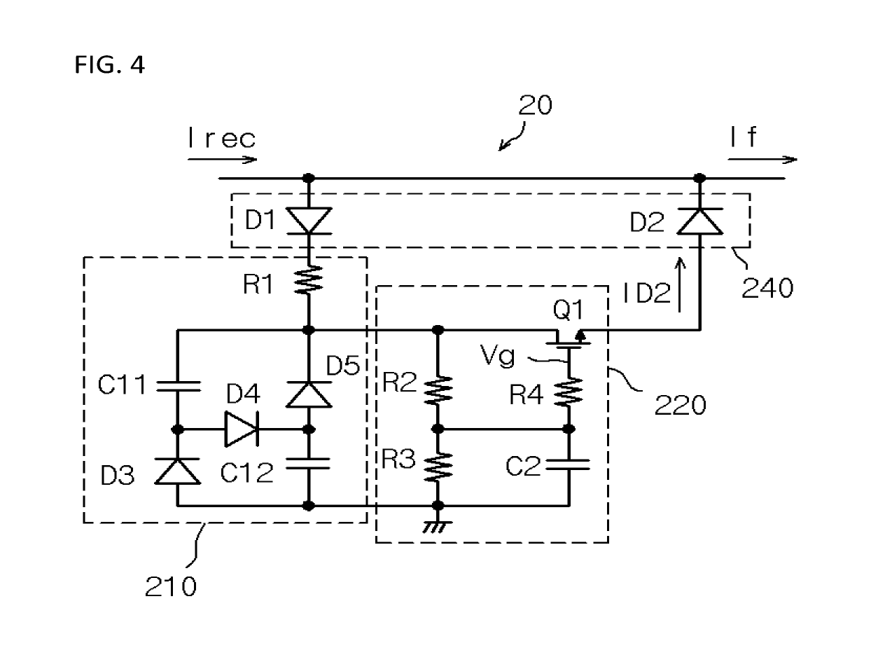

The above-described charge and discharge module may include a capacitor as illustrated in FIG. 3 or include a valley-fill circuit as illustrated in FIG. 4. The discharge current may correspond to a current ID2 flowing through a diode D2 which will be described below.

The flicker reduction circuit 20 may include a switching element having a current control characteristic based on a predetermined gate voltage Vg, and the switching element may provide the discharge current ID2 to a plurality of LED channels during the discharge period. The switching element may correspond to an NMOS transistor Q1 which will be described.

The discharge period may include the lowest-current point at which the current provided to the plurality of LED channels LED1 to LED4 by the rectified voltage Vrec has the lowest level. More specifically, the discharge period may be set to a period in which the rectified voltage Vrec becomes lower than the output voltage of the NMOS transistor Q1 serving as a switching element. The output voltage of the NMOS transistor Q1 may be defined as a voltage obtained by subtracting the gate-source voltage Vgs of the transistor Q1 from the gate voltage Vg. The discharge period may be adjusted by varying the level of the gate voltage Vg, and the gate voltage Vg may be set to have the same level as or a higher level than the rectified voltage Vrec which causes one or more of the LED channels LED1 to LED4 to emit light.

The gate voltage Vg may be stored in a capacitor at the gate of the switching element, and have a level which is determined through a voltage applied to a resistor connected in parallel to the capacitor. For this operation, the resistor connected in parallel to the capacitor may be used to divide the rectified voltage Vrec. Desirably, the resistor may be implemented with a variable resistor.

Referring to FIG. 3, the configuration of the flicker reduction circuit 20 will be described in more detail. The flicker reduction circuit 20 may include a charge and discharge module 200, a discharge control circuit 220, and an inverse voltage control circuit 240.

First, the charge and discharge module 200 may be charged to the rectified voltage Vrec, and provide a discharge current ID2 to the plurality of LED channels LED1 to LED4.

For this operation, the charge and discharge module 200 may include a resistor R1 and a capacitor C1 which are connected in series. The voltage stored in the capacitor C1 may be referred to as a charge voltage Vc1. The resistor R1 may be configured to receive a current Irec formed by the rectified voltage Vrec through a diode D1 of the inverse voltage control circuit 240.

In the above-described configuration, the capacitor C1 may perform charging in response to the rectified voltage Vrec. The rectified voltage Vrec may have a lower level than the charge voltage Vc1 due to the ripple characteristic. When the charge voltage Vc1 is higher than the rectified voltage Vrec, an inverse voltage may occur, but a current formed by the inverse voltage may be blocked by the diode D1.

The discharge control circuit 220 may include a switching element having a current control characteristic based on a preset gate voltage Vg. During a discharge period in which the rectified voltage Vrec becomes lower than the output voltage level of the NMOS transistor Q1, the discharge control circuit 220 may control transmission of the discharge current ID2 formed by the charge voltage Vc1 to the plurality of LED channels LED1 to LED4.

For this operation, the discharge control circuit 220 may include resistors R2 and R3, a capacitor C2, an NMOS transistor Q1, and a resistor R4. The resistors R2 and R3 may be connected in series between the resistor R1 and the ground. The capacitor C2 may be connected in parallel to the resistor R3. The NMOS transistor Q1 may be configured as a switching circuit which controls a current flow between a diode D2 of the inverse voltage control circuit 240 and a node between the capacitor C1 and the resistor R1 of the charge and discharge module 200. The resistor R4 may be formed between the gate of the NMOS transistor Q1 and the capacitor C2.

The resistors R2 and R3 may be connected in parallel to the capacitor C1 of the charge and discharge module 200, and serve as a divider circuit to provide a voltage for charging the capacitor C2. Furthermore, the node between the resistors R2 and R3 and the node between the resistor R4 and the capacitor C2 may be connected to each other. The resistor R3 may be implemented with a variable resistor.

The NMOS transistor Q1 may only indicate one of switching elements. Instead of the switching element, the NMOS transistor Q1 may be selected from a field effect transistor, a bipolar transistor, and a MOS transistor.

In the above-described configuration, the rectified voltage Vrec having the same level as the voltage applied to the capacitor C1 may be applied to the resistors R2 and R3, and the voltage divided by the resistors R2 and R3 may be stored in the capacitor C2. The capacitor C2 may provide the stored voltage to the gate of the NMOS transistor Q1. That is, the charge voltage of the capacitor C2 may correspond to the gate voltage Vg. The capacitor C2 may have a smaller capacity than the capacitor C1, and provide the gate voltage Vg at a constant level. The gate voltage Vg of the capacitor C2 may be determined by the resistance value of the resistor R3. That is, when the resistance value of the resistor R3 is high, the gate voltage Vg of the capacitor C2 may have a high level, and when the resistance value of the resistor R3 is low, the gate voltage Vg of the capacitor C2 may have a low level.

The NMOS transistor Q1 may have a current control characteristic based on the gate voltage Vg formed by the rectified voltage. When the charge voltage Vc1 of the capacitor C1 is higher than the rectified voltage Vrec, the NMOS transistor Q1 may transmit the discharge current ID2 formed by the charge voltage Vc1 to the plurality of LED channels LED1 to LED4 through the diode D2. That is, when the rectified voltage Vrec becomes lower than the output voltage of the NMOS transistor Q1, the NMOS transistor Q1 may transmit the discharge current ID2 formed by the charge voltage Vc1 to the plurality of LED channels LED1 to LED4 through the diode D2.

The diodes D1 and D2 may be included in the inverse voltage control circuit 240. As described above, the diode D1 may pass the current Irec formed by the rectified voltage Vrec to the charge and discharge module 200, and block a current from flowing into a path through which the rectified voltage Vrec is provided to the plurality of LED channels LED1 to LED4 from the charge and discharge module 200. Furthermore, the diode D2 may pass the discharge current ID2 to the plurality of LED channels LED1 to LED4 in response to the discharge period, and block the light emitting current If from flowing into the discharge control circuit 220.

The flicker reduction circuit 20 may include a charge and discharge module 210 implemented with a valley-fill circuit as illustrated in FIG. 4. Since the discharge control circuit 220 and the inverse voltage control circuit 240 are configured in the same manner as illustrated in FIG. 3, the duplicated descriptions thereof are omitted herein.

In FIG. 4, the charge and discharge module 210 may include a plurality of capacitors C11 and C12. For charging, the plurality of capacitors C11 and C12 may be equivalently arranged in series to the rectified voltage Vrec. For discharging, the plurality of capacitors C11 and C12 may be equivalently arranged in parallel to the rectified voltage Vrec.

For this configuration, the capacitor C11, a diode D4, and the capacitor C12 in the charge and discharge module 210 may be connected in series to the resistor R1, and the diode D4 may be configured in the forward direction. A diode D3 may be configured in the backward direction between the ground and the node between the capacitor C11 and the diode D4. Furthermore, a diode D5 may be configured in the backward direction between the resistor R1 and the node between the diode D4 and the capacitor C12.

In the case of charging, the current Irec may flow through a path including the capacitor C11, the diode D4, and the capacitor C12. Thus, the capacitor C11 and the capacitor C12 may be charged. In the case of discharging, a current formed by the charge voltage of the capacitor C11 and a current formed by the charge voltage of the capacitor C12 may be provided to the NMOS transistor Q1 through the node between the resistor R1 and the diode D5.

When supposing that the capacitors C1, C11, and C12 have the same capacity, the charge voltages of the capacitors C11 and C12 may correspond to ½ of the charge voltage Vc1 of the capacitor C1 of FIG. 3, and the charge formed by the discharge current ID2 provided to the NMOS transistor Q1 may be doubled. At this time, the gate voltage Vg of the capacitor C2 may be set to be lower than the charge voltages of the capacitors C11 and C12.

As the embodiment of the present invention is configured as described above, the flicker reduction operation can be performed.

First, referring to FIG. 5, the operation of a control circuit of a conventional LED lighting apparatus will be described. In this case, suppose that the flicker reduction circuit 20 is not operated.

When the rectified voltage Vrec is in the initial state, the plurality of LED channels LED1 to LED4 may not emit light. Thus, the current sensing resistor Rs may provide a low-level current sensing voltage.

When the rectified voltage Vrec is in the initial state, the reference voltages VREF1 to VREF4 applied to the positive input terminal (+) of the comparator 38 may be higher than the current sensing voltage applied to the negative input terminal (−) of the comparator 38. Thus, all the NMOS transistors 39 of the respective switching circuits 31 to 34 may maintain a turned-on state. Hereafter, the turn-on/off of the switching circuits 31 to 34 may indicate turn-on/off of the NMOS transistor 39.

Then, when the rectified voltage Vrec rises to reach the light emitting voltage V1, the LED channel LED1 of the lamp LA may emit light. Then, when the LED channel LED1 of the lamp LA emits light, the switching circuit 31 connected to the LED channel LED1 may provide a current path.

When the rectified voltage Vrec reaches the light emitting voltage V1 such that the LED channel LED1 emits light and the current path is formed through the switching circuit 31, the level of the current sensing voltage of the current sensing resistor Rs may rise. However, since the level of the current sensing voltage is low, the turned-on states of the switching circuits 31 to 34 are not changed.

Then, when the rectified voltage Vrec continuously rises to reach the light emitting voltage V2, the LED channel LED2 of the lamp LA may emit light. When the LED channel LED2 of the lamp LA emits light, the switching circuit 32 connected to the LED channel LED2 may provide a current path. At this time, the LED channel LED1 may maintain the light emitting state.

When the rectified voltage Vrec reaches the light emitting voltage V2 such that the LED channel LED2 emits light and the current path is formed through the switching circuit 32, the level of the current sensing voltage of the current sensing resistor Rs may rise. At this time, the current sensing voltage may have a higher level than the reference voltage VREF1. Therefore, the NMOS transistor 39 of the switching circuit 31 may be turned off by an output of the comparator 38. That is, the switching circuit 31 may be turned off, and the switching circuit 32 may provide a selective current path corresponding to the light emission of the LED channel LED2.

Then, when the rectified voltage Vrec continuously rises to reach the light emitting voltage V3, the LED channel LED3 of the lamp LA may emit light. When the LED channel LED3 of the lamp LA emits light, the switching circuit 33 connected to the LED channel LED3 may provide a current path. At this time, the LED channels LED1 and LED2 may also maintain the light emitting state.

When the rectified voltage Vrec reaches the light emitting voltage V3 such that the LED channel LED3 emits light and the current path is formed through the switching circuit 33, the level of the current sensing voltage of the current sensing resistor Rs may rise. At this time, the current sensing voltage may have a higher level than the reference voltage VREF2. Therefore, the NMOS transistor 39 of the switching circuit 32 may be turned off by the output of the comparator 38. That is, the switching circuit 32 may be turned off, and the switching circuit 33 may provide a selective current path corresponding to the light emission of the LED channel LED3.

Then, when the rectified voltage Vrec continuously rises to reach a light emitting voltage V4, the LED channel LED4 of the lamp LA may emit light. Then, when the LED channel LED4 of the lamp LA emits light, the switching circuit 34 connected to the LED channel LED4 may provide a current path. At this time, the LED channels LED1, LED2, and LED3 may also maintain the light emitting state.

When the rectified voltage Vrec reaches the light emitting voltage V4 such that the LED channel LED4 emits light and the current path is formed through the switching circuit 34, the level of the current sensing voltage of the current sensing resistor Rs may rise. At this time, the current sensing voltage may have a higher level than the reference voltage VREF3. Therefore, the NMOS transistor 39 of the switching circuit 33 may be turned off by the output of the comparator 38. That is, the switching circuit 33 may be turned off, and the switching circuit 34 may provide a selective current path corresponding to the light emission of the LED channel LED4.

Then, although the rectified voltage Vrec continuously rises, the switching circuit 34 may maintain the turned-on state, because the reference voltage VREF4 provided to the switching circuit 34 has a higher level than the current sensing voltage formed at the current sensing resistor Rs by the upper limit level of the rectified voltage Vrec.

When the LED channels LED1 to LED4 sequentially emit light in response to the rises of the rectified voltage Vrec, the current corresponding to the light emitting states may increase in a stepwise manner as illustrated in FIG. 5. That is, since the current control circuit 30 performs a current regulation operation, a current corresponding to light emission of each LED channel may be sustained at a constant level. When the number of LED channels to emit light increases, the level of the current may rise in response to the increase.

After rising to the upper limit level as described above, the rectified voltage Vrec may start to fall.

When the rectified voltage Vrec falls below the light emitting voltage V4, the LED channel LED4 of the lamp LA may be turned off.

When the LED channel LED4 is turned off, the lamp LA may maintain the light emitting state through the LED channels LED1 to LED3. Thus, the current path may be formed through the switching circuit 33 connected to the LED channel LED3.

Then, when the rectified voltage Vrec sequentially falls below the light emitting voltage V3, the light emitting voltage V2, and the light emitting voltage V1, the LED channels LED3, LED2, and LED1 of the lamp LA may be sequentially turned off.

As the LED channels LED3, LED2, and LED1 of the lamp LA are sequentially turned off, the current control circuit 30 may sequentially provide a current path through the switching circuits 33, 32, and 31. Furthermore, as the LED channels LED3, LED2, and LED1 of the lamp LA are sequentially turned off, the level of the current may also decrease in a stepwise manner.

The control circuit of the conventional LED lighting apparatus may be configured to include a turn-off period of the entire lamp LA, the turn-off period including the lowest current point at which the amount of current is the lowest as illustrated in FIG. 5. The turn-off period of the entire lamp may be defined as a flicker occurrence period.

That is, when LED lighting apparatus enters the valley period of the rectified voltage Vrec formed by the ripple characteristic, that is, the flicker occurrence period, the amount of current supplied to the LED channels LED1 to LED4 may be reduced to turn off the entire LED channels LED1 to LED4 of the lamp LA. As a result, a flicker may occur.

In the embodiment of the present invention, the discharge period may be set to include a valley period in which the ripple of the rectified voltage Vrec decreases to the lowest point and then increases, that is, a turn-off period of the entire lamp LA. During a discharge period, valley-fill may be performed by the charge current ID2 of the charge and discharge module 200 or 210. As a result, the light emitting current If may be obtained by adding the current Irec formed by the rectified voltage Vrec and the charge current ID2, and transmitted to the lamp LA. The light emitting current If may be sustained without a large deviation even during the discharge period. That is, the lamp LA may maintain light emission at a predetermined level or more. As a result, the occurrence of a flicker can be reduced.

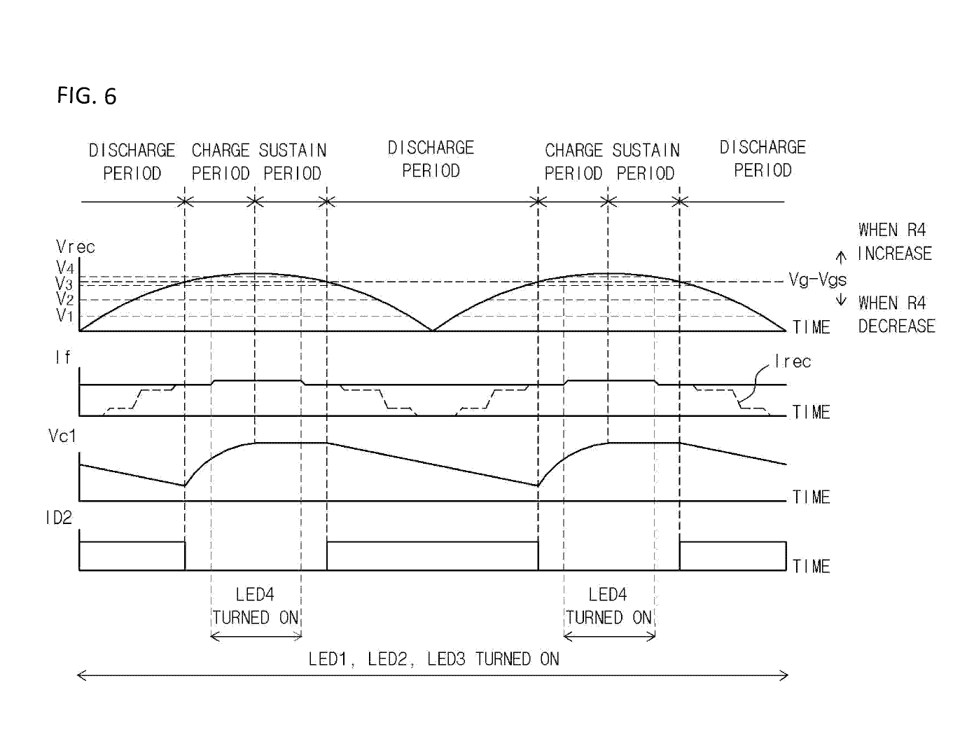

Referring to FIG. 6, the operation of the control circuit of the LED lighting apparatus in accordance with the embodiment of the present invention will be described. In order to describe the operation, the embodiment of FIG. 3 may be referred to.

In the embodiment of the present invention, a discharge period, a charge period, and a sustain period may be set according to the change of the charge voltage Vc1. The discharge period is where the level of the rectified voltage Vrec is lower than the charge voltage Vc1, and the charge period and the sustain period are where the level of the rectified voltage Vrec is equal to or higher than the charge voltage Vc1. Furthermore, the discharge period is where the level of the rectified voltage Vrec is lower than the output voltage of the NMOS transistor Q1, and the charge period and the sustain period are where the level of the rectified voltage Vrec is equal to or higher than the output voltage of the NMOS transistor Q1. The level of the charge voltage Vc1 of the capacitor C1 gradually falls in the discharge period, gradually rises in the charge period, and is sustained in the sustain period. Furthermore, the gate voltage Vg of the capacitor C2 may sustain a constant level, because the environment in which a higher voltage than the preset charge voltage is applied at all times is maintained.

First, during the charge period, the rectified voltage Vrec may have a higher level than the output voltage of the NMOS transistor Q1, stored in the capacitor C2. At this time, a current path may be formed to include the diode D1, the resistor R1, and the capacitor C1, and the capacitor C1 may be charged by the current Irec formed by the rectified voltage Vrec.

That is, the charge voltage Vc1 may gradually rise as illustrated in FIG. 6. At this time, the source-gate voltage of the NMOS transistor Q1 may not be formed at such a level to turn on the NMOS transistor Q1. Thus, a current path may not be formed by the current transistor Q1 As a result, the light emitting current If corresponding to the current Irec formed by the rectified voltage Vrec may be provided to the plurality of LED channels LED1 to LED4.

FIG. 6 illustrates that the output voltage of the NMOS transistor Q1 is formed at the light emitting voltage V3 or more. Thus, when the charge period is started, the LED channels LED1, LED2, and LED3 may be already in the light emitting state. When the rectified voltage Vrec rises over the light emitting voltage V4 during the charge period, the LED channel LED4 may additionally emit light.

The capacitor C1 may be completely charged before or when the rectified voltage Vrec reaches the maximum value.

When the capacitor C1 is completely charged and the charge voltage Vc1 reaches the maximum value, the sustain period may be started. After the sustain period, the rectified voltage Vrec may reach the maximum value, and then start to fall. When the level of the rectified voltage Vrec becomes lower than the output voltage of the NMOS transistor Q1, the sustain period may be ended, and the discharge period may be started. In the sustain period, the rectified voltage Vrec may have a level equal to or higher than the charge voltage Vc1. Therefore, the amount of the light emitting current If provided to the LED channels LED1 to LED4 may be determined by the rectified voltage Vrec. Then, when the rectified voltage Vrec falls below the light emitting voltage V4 while the discharge period is sustained, the LED channel LED4 may be turned off.

During the discharge period, the rectified voltage Vrec may have a lower level than the output voltage of the NMOS transistor Q1. The charge voltage Vc1 may have a higher level than the rectified voltage Vrec. Furthermore, the source-gate voltage of the NMOS transistor Q1 may be formed at such a level to turn on the NMOS transistor Q1. Therefore, the discharge current ID2 formed by the charge voltage Vc1 of the capacitor C1 may be provided to the LED channels LED1 to LED4 through a current path including the NMOS transistor Q1 and the diode D2.

As a result, the light emitting current If obtained by adding the discharge current ID2 and the current Irec formed by the rectified voltage Vrec may be provided to the plurality of LED channels LED1 to LED4.

Then, although the rectified voltage Vrec falls below than the light emitting voltages V3, V2, and V1 during the discharge period, the light emitting current If may be sustained at such a level to turn on the LED channels LED1 to LED3 through the discharge current ID2 formed by the charge voltage Vc1. Thus, during the discharge period, the light emitting states of the LED channels LED1 to LED3 may be sustained.

While the charge period, the sustain period, and the discharge period are repeated, the light emitting states of the LED channels LED1 to LED3 may be sustained, and only the LED channel LED4 may be repetitively turned on and off.

In the embodiments of the present invention, a flicker occurrence period in which the entire lamp is turned off as described above is not formed. Furthermore, luminance may be controlled so as to sustain a minimum luminance difference.

Similarly, in the embodiment which includes the charge and discharge module 210 employing the valley-fill circuit as illustrated in FIG. 4, the light emitting states of the LED channels LED1 to LED3 may be sustained while the charge period, the sustain period, and the discharge period are repeated, and only the LED channel LED4 may be repetitively turned on and off.

As described above, the LED lighting apparatus which is driven through the rectified voltage Vrec can sustain luminance at a predetermined level or more without a turn-off period of the entire lamp. Therefore, a flicker can be reduced.

Furthermore, the control circuit in accordance with the embodiment of the present invention can sufficiently reduce a flicker using the capacitors having a small capacity. Thus, although the capacitors are applied, the reduction of lifetime or power factor can be minimized, and a flicker can also be reduced.

Furthermore, since a charge operation for flicker reduction is performed at a lower level than the peak value (maximum value) of the rectified voltage, the control circuit can prevent a charge operation by an excessive voltage, thereby minimizing power consumption.

As a result, the reliability of the LED lighting apparatus in accordance with the embodiment of the present invention can be improved.

In accordance with the embodiments of the present invention, the control circuit of the LED lighting apparatus can reduce a flicker by performing a charge and discharge operation using a rectified voltage, thereby improving the reliability of the LED lighting apparatus which is driven by the rectified voltage.

Furthermore, the control circuit may perform a voltage charge and discharge operation using capacitors having a small capacity, thereby reducing a flicker. Thus, the control circuit can minimize reduction in lifetime or power factor and reduce a flicker, even though the capacitors are applied.

While various embodiments have been described above, it will be understood to those skilled in the art that the embodiments described are by way of example only. Accordingly, the disclosure described herein should not be limited based on the described embodiments.

What is claimed is:

1. A control circuit of a light emitting diode (LED) lighting apparatus which includes a plurality of LED channels, the control circuit comprising:
a current control circuit configured to provide a current path corresponding to light emissions of the plurality of LED channels in response to a rectified voltage; and
a flicker reduction circuit comprising a charge and discharge module charged to the rectified voltage and providing a discharge current to the plurality of LED channels, and configured to provide the discharge current to the plurality of LED channels during a discharge period including the lowest current point at which the level of the current supplied to the plurality of LED channels is the lowest.

2. The control circuit of claim 1, wherein the charge and discharge module comprises a first capacitor or valley-fill circuit.

3. The control circuit of claim 2, wherein the valley-fill circuit comprises a plurality of second capacitors, and
the plurality of second capacitors are equivalently arranged in series to the rectified voltage, for a charge operation, and equivalently arranged in parallel to the rectified voltage, for a discharge operation.

4. The control circuit of claim 1, wherein the flicker reduction circuit comprises a switching element, and has a current control characteristic based on a preset gate voltage of the switching element using a voltage stored through the rectified voltage, and
during the discharge period in which the rectified voltage falls below the level of an output voltage of the switching element, the discharge current is provided to the plurality of LED channels.

5. The control circuit of claim 4, wherein the switching element is selected from a field effect transistor, a bipolar transistor, and a MOS transistor.

6. The control circuit of claim 4, wherein the gate voltage has the same level as or a higher level than the rectified voltage at which one or more of the LED channels emit light.

7. The control circuit of claim 4, wherein the gate voltage is stored in a capacitor at the gate of the switching element, and the level of the gate voltage is determined according to a voltage applied to a resistor connected in parallel to the capacitor.

8. The control circuit of claim 7, wherein the resistor serves to divide the rectified voltage.

9. The control circuit of claim 7, wherein the resistor comprises a variable resistor.

10. The control circuit of claim 1, wherein the flicker reduction circuit comprises:
the charge and discharge module charged to the rectified voltage and configured to provide the discharge current to the plurality of LED channels; and
a discharge control circuit comprising a switching element having a current control characteristic based on a preset gate voltage, and configured to provide the discharge current to the plurality of LED channels during the discharge period in which the rectified voltage falls below the level of an output voltage of the switching element.

11. The control circuit of claim 10, further comprising:
a first diode configured to pass a first current formed by the rectified voltage to the charge and discharge module, and block a second current from flowing into a path through which the rectified voltage is provided to the plurality of LED channels from the charge and discharge module; and
a second diode configured to pass the discharge current to the plurality of LED channels in response to the discharge period, and block a third current from flowing into the discharge control circuit, the third current being supplied to the plurality of LED channels by the rectified voltage.

12. The control circuit of claim 10, wherein the discharge control circuit comprises:
the switching element having a current control characteristic based on the gate voltage, and configured to provide the discharge current of the charge and discharge module to the plurality of LED channels;
a capacitor configured to provide the gate voltage to the switching element; and
a divider circuit connected to a node to which the rectified voltage of the charge and discharge module is applied, and configured to provide a voltage for charging the capacitor, and
during the discharge period in which the rectified voltage falls below the level of an output voltage of the switching element, the control circuit guarantees a flow of the discharge current.

13. A control circuit of an LED lighting apparatus which includes a plurality of LED channels, the control circuit comprising a flicker reduction circuit formed at a position to which a rectified voltage for the plurality of LED channels is applied,
wherein the flicker reduction circuit comprises:
a charge and discharge module charged to the rectified voltage and configured to provide a discharge current to the plurality of LED channels; and
a discharge control circuit configured to provide the discharge current of the charge and discharge module to the plurality of LED channels during a discharge period including the lowest current period at which the amount of current supplied to the plurality of LED channels is the lowest.

14. The control circuit of claim 13, wherein the discharge control circuit comprises:
a switching element having a current control characteristic based on a preset gate voltage using a voltage stored by the rectified voltage, and configured to provide the discharge current of the charge and discharge module to the plurality of LED channels;
a capacitor configured to provide the gate voltage to the switching element; and
a divider circuit connected to a node to which the rectified voltage of the charge and discharge module is applied, and configured to provide a voltage for charging the capacitor, and
during the discharge period in which the rectified voltage falls below the level of an output voltage of the switching element, the control circuit guarantees a flow of the discharge current.

15. The control circuit of claim 14, wherein the switching element is selected from a field effect transistor, a bipolar transistor, and a MOS transistor.

16. The control circuit of claim 14, wherein the gate voltage has the same level as or a higher level than the rectified voltage which turns on one or more of the LED channels.
